(19) United States
(12) Patent Application Publication
(10) Pub. No.: US 2008/0155428 A1
(43) Pub. Date: Jun. 26, 2008

(54) METHOD OF DISPLAYING MENU BASED ON USE RECORD IN MOBILE TERMINAL

(75) Inventor: Jong Seong LEE, Tokyo (JP)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/942,482

(22) Filed: Nov. 19, 2007

(30) Foreign Application Priority Data
Dec. 20, 2006 (KR) 2006-0130551

(51) Int. Cl. G06F 3/00

(52) U.S. Cl. 715/745

(57) ABSTRACT

A method of displaying a menu in a mobile terminal based on a use record, such as a use ranking and a use history, is provided. The method of displaying a menu based on a use record in a mobile terminal includes selecting one of at least two highest level menus; extracting a use record of lowest level items corresponding to the selected highest level menu; and displaying the selected highest level menu and the lowest level items based on the use record. Therefore, by simultaneously displaying a use ranking and a use history on a screen and enabling a user to rapidly access a desired item, it is unnecessary to pass through several manipulation operations, and a display item is immediately updated according to the use record, whereby a user can effectively use the item.

### PRIORITY

This application claims priority to a Korean Patent Application filed in the Korean Intellectual Property Office on Dec. 20, 2006 and assigned Serial No. 2006-0130551, the contents of which are incorporated herein by reference.

### BACKGROUND OF THE INVENTION

1. Field of the Invention

The present invention relates to a method of displaying a menu in a mobile terminal, and more particularly, to a method of displaying a menu in a mobile terminal based on a use record such as a use ranking and a use history.

2. Description of the Related Art

Due to development of telecommunication technology and semiconductor technology, various mobile terminals have been widely used. Nowadays, mobile terminals have their intrinsic functions as well as functions typically found in other terminals. Specifically, the mobile terminals have various multimedia functions such as a television viewing function (for example, mobile broadcasting such as Digital Multimedia Broadcasting (DMB)), music reproducing function (for example, an MP3 player), and photographing function as well as a general communication function such as voice communication or transmission and reception of a message.

As the mobile terminals have various and sometimes complex functions, the quantity of functions and content available to a user have been gradually increased. However, a menu structure of the mobile terminals based on a hierarchical tree structure has been little changed for at least a decade. A current menu structure of the mobile terminals has problems such as increase of manipulation steps due to multiple available functions, and complexity of a screen hierarchy structure, and access error due to a single error within a multiple step process, and therefore is a structure unfriendly to the user. Further, items displayed in the menu structure are classified in consideration of the characteristics and inclinations of a target user, without considering usage characteristics of an individual user.

FIG. 1 is a diagram illustrating menus having a conventional tree structure.

As shown in FIG. 1, a general menu structure 10 of the mobile terminal is a so-called tree structure in which menu items are formed in several levels. Items such as a function or content actually used by the user in the tree structure are positioned at the lowest level (for example, ‘A11’, ‘B11’, and ‘C11’). Therefore, in order for the user to access a desired item, upper levels of the corresponding item must be sequentially passed through. For example, in order to access an item ‘B12’, items ‘B’ and ‘B1’ in levels higher than the item ‘B12’ must be sequentially passed through.

In such a method of accessing a menu, the menu is displayed in a display unit of a mobile terminal as follows.

FIGS. 2A to 2C are examples of a screen illustrating a conventional method of displaying a menu.

When a user selects a menu, highest level items (A, B, C, etc.) are displayed in a display unit 20 of the mobile terminal, as shown in FIG. 2A. If the user selects item ‘B’, lower level items ‘B1’, ‘B2’, and ‘B3’ of item ‘B’ are displayed, as shown in FIG. 2B. If item ‘B1’ is selected, the lowest level items ‘B11’ and ‘B12’ are displayed, as shown in FIG. 2C. Finally, the user can execute a desired function or content by selecting item ‘B12’.

In the conventional method of displaying a menu, items in each level of a menu structure are displayed in a bundle. The menu structure 10 of FIG. 1 is shown to describe a concept of the conventional method of displaying a menu, however an actual menu structure may have more levels and items than the menu structure 10 of FIG. 1. If the menu structure has more levels and items, the method of displaying a menu as shown in FIGS. 2A to 2C becomes complicated, and the number of times of manipulation for accessing an item requested by the user increases. Accordingly, it is not easy to find and access a desired item, and a case of inadvertently accessing an undesired item may arise.

Instead of a method of accessing a desired menu item in an hierarchy of levels, a method of directly accessing a desired menu item through a shortcut exists. However, this method requires a process of registering a shortcut, and the quantity of shortcuts available to register is limited. Further, after a time, a registered item may no longer be important to a user. In this case, a manipulation process of deleting the registered item and registering another item is required.

In consideration of the user's characteristics or inclination, a classification system of items in a menu structure of a mobile terminal may be set. For example, in a product for a younger person, items related to a multimedia function may be subdivided, whereas in a product for an elder person, only a basic function may be provided. However, even if the mobile terminal has a different menu structure, there is a limitation in constructing a menu structure in consideration of the user's individual using characteristics.

### SUMMARY OF THE INVENTION

The present invention has been made in an effort to solve the above problems, and the present invention provides a method of displaying a menu in a mobile terminal that can easily access an item requested by a user.

The present invention further provides a method of displaying a menu in a mobile terminal that can be conveniently manipulated by a user.

The present invention further provides a method of displaying a menu in a mobile terminal that can reflect the user's individual using characteristics.

In accordance with an aspect of the present invention, a method of displaying a menu based on a use record in a mobile terminal includes selecting one of at least two highest level menus; extracting a use record of the lowest level items corresponding to the selected highest level menu; and displaying the selected highest level menu and the lowest level items based on the use record.

In accordance with another aspect of the present invention, a method of displaying a menu based on a use record in a mobile terminal includes selecting a highest level menu among at least two highest level menus; extracting a use record, comprising a use ranking and a use history, of the lowest level items corresponding to the selected highest level menu; displaying the selected highest level menu on a screen; and displaying the lowest level items corresponding to the selected highest level menu on the screen based on the use record.

The method may further include selecting, by input of a leftward direction key or a rightward direction key after the lowest level items are displayed, another highest level menu among the highest level menus; extracting a use record of the lowest level items corresponding to the newly selected highest level menu; displaying the newly selected highest level menu on a screen; and displaying the lowest level items corresponding to the newly selected highest level menu on the screen based on the use record.

Displaying the selected highest level menu on a screen may include displaying the selected highest level menu at the center of the screen, and displaying the lowest level items on the screen may include displaying the lowest level items in each of an upper area and a lower area of the screen based on the use ranking and use history, respectively.

Displaying the lowest level items on the screen may include disposing lowest level items having one of a highest use ranking and a most recently use history at positions adjacent to the selected highest level menu.

Displaying the selected highest level menu on a screen may include displaying the selected highest level menu and the remaining highest level menus, wherein the selected highest level menu is displayed to be identified as the selected highest level menu among the highest level menus.

Selecting a highest level menu among at least two highest level menus may include selecting a highest level menu of a most recently used lowest level item.

The method may further include displaying, if an upward direction key is input after displaying the lowest level items, the selected highest level menu at the lower end of the screen; and displaying the lowest level items in the upper area of the screen based on the used ranking.

The method may further include displaying, if a downward direction key is input after displaying the lowest level items, the selected highest level menu at the upper end of the screen; and displaying the lowest level items in the lower area of the screen based on the use history.

The method may further include displaying a focus at a lowest level item adjacent to the selected highest level menu.

The method may further include executing, if a selection key is input, a function of the lowest level item at which the focus is displayed, and updating the use record.

### BRIEF DESCRIPTION OF THE DRAWINGS

The aspects, features and advantages of the present invention will be more apparent from the following detailed description in conjunction with the accompanying drawings, in which:

FIG. 1 is a diagram illustrating menus having a conventional tree structure;

FIGS. 2A to 2C are examples of a screen illustrating a conventional method of displaying a menu;

FIG. 3 is an example of a use record to be used in a method of displaying a menu according to an exemplary embodiment of the present invention;

FIGS. 4A to 4D are examples of a screen illustrating a method of displaying a menu according to an exemplary embodiment of the present invention;

FIGS. 5A to 5C are examples of a screen applying the method of displaying a menu of FIGS. 4A to 4C;

FIG. 6 is a block diagram illustrating a configuration of a mobile terminal for performing a method of displaying a menu according to another exemplary embodiment of the present invention;

FIG. 7 is a flowchart illustrating a method of displaying a menu according to another exemplary embodiment of the present invention;

FIG. 8 is a flowchart illustrating a process of displaying a menu in the method of displaying a menu of FIG. 7; and

FIG. 9 is a flowchart illustrating a process of redisplaying a menu in the method of displaying a menu of FIG. 7.

### DETAILED DESCRIPTION OF EXEMPLARY EMBODIMENTS

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

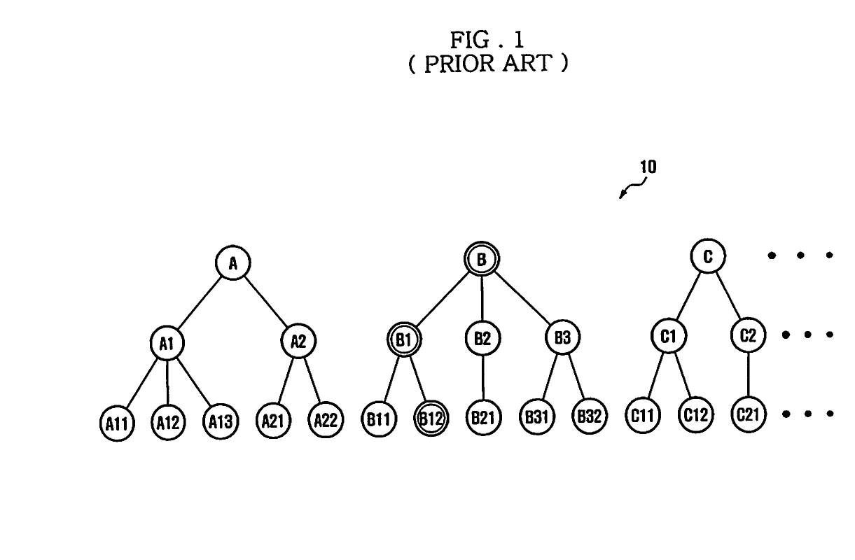

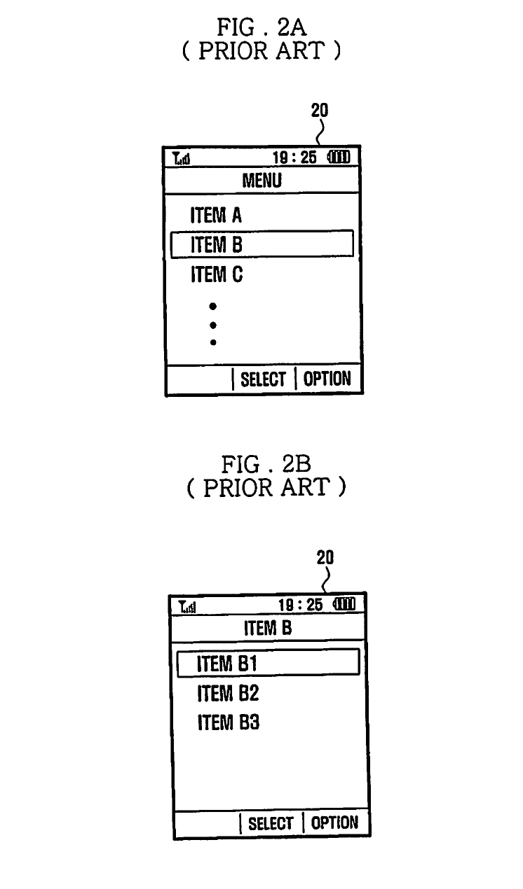

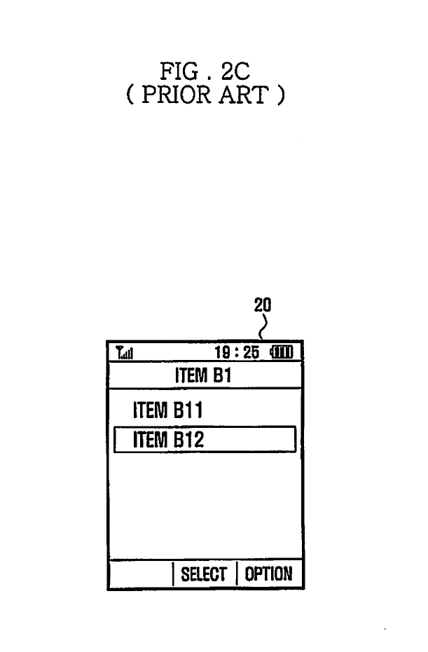

It is assumed that a mobile terminal has the menu structure 10 of FIG. 1. The menu structure 10 of FIG. 1 is a simplified example only for explanation purpose, and an actual menu structure may have more complex levels and items. Further, in the menu structure 10 of FIG. 1, the quantity of steps to pass through in order to access a lowest level item is identical for each item, however in an actual menu structure, the quantity of steps to pass through in order to access a lowest level item may be different for each item.

A menu item positioned at a lowest level of the menu structure 10 can be classified into two types. A first type is a function or content to be used by a user, for example, a function of a menu for executing or setting some application, or a multimedia content stored in a mobile terminal. A second type is an event generated in a mobile terminal, for example, transmission and reception of voice communication and transmission and reception of a message.

In this specification, in the first type of menu item, a ‘use’ of a menu item means to ‘enter’ the menu by selecting the function or the content, i.e. to ‘execute’ an item, not to just select the function or the content; and in the second type of menu item, a ‘use’ of a menu item indicates ‘generation’ of the event. A ‘use record’ of menu item includes a use ranking and a use history. The ‘use ranking’ indicates a number of times of use of each menu item, and the ‘use history’ indicates the points in time of use of each menu item. The use ranking may be the number of times of use of an item, and the use history may be an order of the most recent use of an item based on the time point of use of the item.

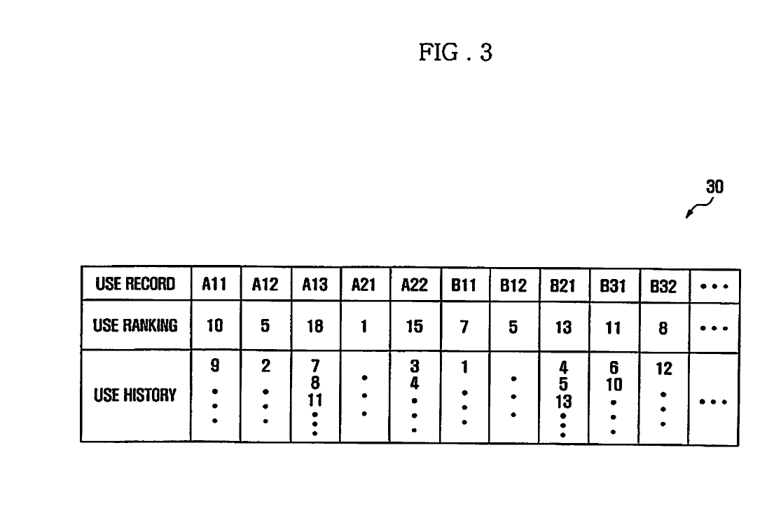

FIG. 3 is an example of a use record to be used in a method of displaying a menu according to an exemplary embodiment of the present invention.

It is assumed that each of the lowest level items in the menu structure 10 of FIG. 1 has a use record 30 shown in FIG. 3. For example, an item ‘a11’ has been used 10 times and is the 9-th most recently used item, and an item ‘a13’ has been used 18 times and is the 7-th, 8-th, and 11-th most recently used item.

The use ranking can be calculated for a preset specific time period. For example, the use ranking is the number of times of use during a past one month from the present time. The use history can be calculated for a preset specific period or can be calculated up to a specific order in an order of the most recently used items. In the latter case, for example, the most recently used item to the 100-th most recently used item can be set as the menu items for calculation of a use history. Further, the use history may be calculated for each highest level menu or may be calculated only for each menu item based on information of the most recent use of each item.

Next, a method of displaying a menu using a menu structure and a use record is described through examples of a screen performing the method.

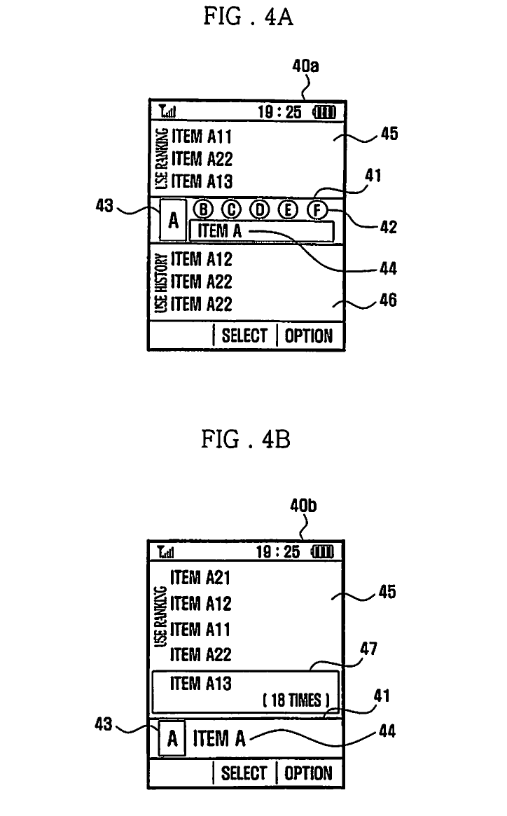

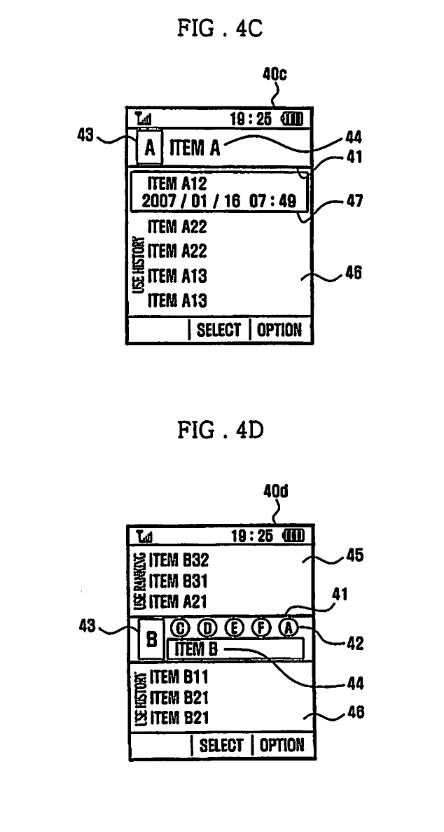

FIGS. 4A to 4D are examples of a screen illustrating a method of displaying a menu according to an exemplary embodiment of the present invention.

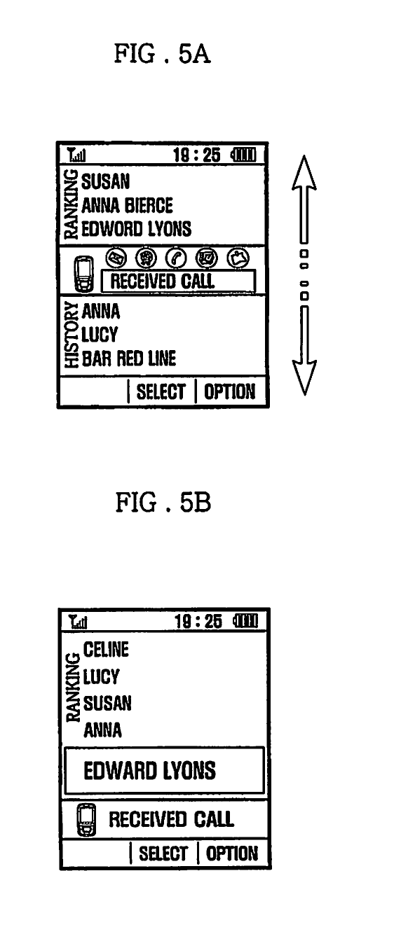

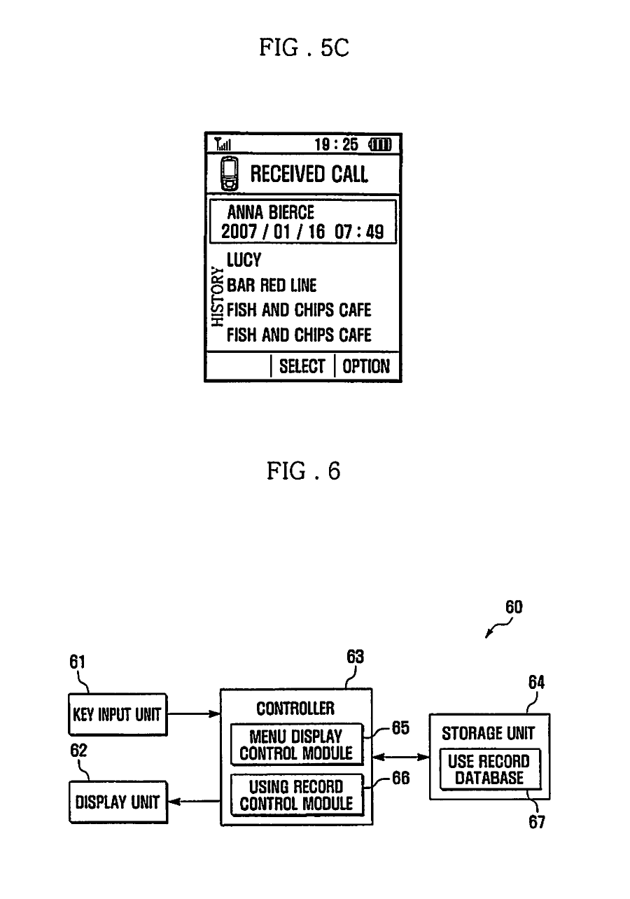

FIGS. 5A to 5C are examples of a screen applying the method of displaying a menu of FIGS. 4A to 4D.

If a menu entry key is input on a standby screen, a menu screen 40a is displayed, as shown in FIG. 4A. At the center of the menu screen 40a, a central bar 41 is displayed in a horizontal direction. At the central bar 41, items (for example, A, B, and C) of the highest level menu are arranged in a form of icons 42, and a first focus 43 is positioned at one of the icons 42. An icon 42 of the item ‘A’ at which the first focus 43 is positioned is displayed larger in size than the icons 42 of the other items (B, C, etc.). A focused item may be identified by a size, color, etc. of the icon 42, and the first focus 43 may be omitted. An item name 44 is displayed next to the item (currently item ‘A’) at which the first focus 43 is positioned.

In an upper area 45 of the screen, positioned above the central bar 41, the lowest level items ‘A11’, ‘A22’, and ‘A13’ are vertically arranged based on a use ranking. Similarly, in a lower area 46 of the screen, positioned below the central bar 41, the lowest level items ‘A12’, ‘A22’, and ‘A13’ are vertically arranged based on a use history. The lowest level items displayed in the upper area 45 and the lower area 46 are items of a lower level of the highest level item ‘A’ at which the first focus 43 is positioned. Items having a higher use ranking or items having a more recent use history are disposed at a position adjacent to the central bar 41.

For example, in a use record of FIG. 3, an order of lowest level items ‘A11’ to ‘A22’ according to a use ranking is ‘A13’, ‘A22’, ‘A11’, ‘A12’, and ‘A21’, and the items are arranged in this order upwards from a position immediately above the central bar 41. Similarly, according to a use history, the items are arranged in the order ‘A12’, ‘A22’, ‘A22’, ‘A13’, ‘A13’, ‘A11’, and ‘A13’, and the items are arranged in this order downwards from a position immediately below the central bar 41. At the left side of the areas 45 and 46, a corresponding phrase is displayed to notify that the items are arranged according to a use ranking and use history, respectively.

A realistic example of the menu screen 40a of FIG. 4A is shown in FIG. 5A. Referring to FIG. 5A, the item ‘A’ is ‘received call’. According to a use ranking, ‘Edward Lyons’, ‘Anna Bierce’, etc. corresponding to lowest level items are displayed in an upper area, and according to a use history, ‘Anna Bierce’, ‘Lucy Ives’, etc. corresponding to lowest level items are displayed in a lower area. In this way, the lowest level items are displayed with an item name, and an icon is displayed at the left side of the item name.

If a user inputs an upward direction key during display of the menu screen 40a in FIG. 4A, a menu screen 40b in FIG. 4B is displayed. On the menu screen 40b, the central bar 41 moves to and is displayed at a lower end of the screen, and the items in the central bar 41 except for the focused highest level item ‘A’ disappear from the central bar 41. As the central bar 41 moves to the lower end of the screen, the lowest level items are displayed only in the upper area 45. A second focus 47 is positioned at the lowest level item ‘A13’ adjacent to the central bar 41, and a use ranking (18 times) of the item ‘A13’ is displayed. However, in other embodiments, the use ranking may be omitted. The second focus 47 is moved upwards sequentially through the items by inputting the upward direction key, and the menu screen 40a of FIG. 4A reappears by inputting the downward direction key.

If the user inputs the downward direction key during display of the menu screen 40a in FIG. 4A, a menu screen 40c in FIG. 4C is displayed. On the menu screen 40c, the central bar 41 moves to and is displayed at an upper end of the screen, and the items in the central bar 41 except for the focused highest level item ‘A’ disappear from the central bar 41. As the central bar 41 moves to the upper end of the screen, the lowest level items are displayed only in the lower area 46. The second focus 47 is positioned at the lowest level item ‘A12’ adjacent to the central bar 41, and a use time point (2007/01/16, 07:49) of the item ‘A12’ is displayed. The second focus 47 is moved downwards sequentially through the items by inputting the downward direction key, and the menu screen 40a in FIG. 4A reappears by inputting the upward direction key.

FIGS. 5B and 5C are realistic examples of the menu screens 40b and 40c in FIGS. 4B and 4C, respectively.

If a rightward direction key is input by the user during display of the menu screen 40a in FIG. 4A, a menu screen 40d in FIG. 4D is displayed. The position of the central bar 41 does not change, and a focused highest level item changes. That is, by inputting a rightward direction key, the icons 42 of the highest level items arranged at the central bar 41 move to the left. Accordingly, an item ‘B’ that was previously at the right side of the item ‘A’ is positioned at a position of the first focus 43, and the item ‘A’ moves to the right side of an end item ‘F’. In this way, if the leftward direction key or the rightward direction key is input, the highest level items move to the left or to the right, respectively. As the focused highest level item changes, the lowest level items displayed in the upper area 45 and the lower area 46 also change.

In the method of displaying a menu, in order to enter the menu screen 40a in FIG. 4A from a standby screen, a hotkey or a communication key to which a menu screen entry function is mapped should be input. When entering the menu screen 40a by inputting the hotkey, it is preferable that the first focus 43 is positioned at a highest level item of the most recently used menu item. When entering the menu screen 40a by inputting the communication key, the first focus 43 may be set to be positioned at a ‘dialed call’, which is one of the highest level items.

For example, the quantity of lowest level items to be displayed on the menu screen may be set to 10 for the use ranking and may be set to 30 for the use history. However, it is preferable that the quantity of the lowest level items that are actually displayed on the menu screen is set to about 4 items in each of the upward and downward directions in the case of FIG. 4A, and is set to about 7 or 8 items in the case of FIG. 4B and in the downward direction in the case of FIG. 4C.

If the entire item name of the displayed highest level item or lowest level item is too long to be displayed on one screen, the item name can be automatically scrolled to the left.

In order to change from a state of focusing a lowest level item of the upper or lower area to a state of focusing the highest level item of the central bar, in a state where the second focus is positioned at an item immediately adjacent to the central bar, a direction key towards the central bar (for example, in the case of the use ranking, a downward direction key) should be input, or in a state where the second focus is positioned at an item farthest from the central bar, a direction key in a direction further away from the central bar (for example, in the case of the use ranking, an upward direction key) should be input.

When the second focus is positioned at a specific lowest level item, if a selection key (or a confirmation key) is input, a function of the corresponding item is executed, and a related screen is displayed, and a use record of the executed item is updated.

A mobile terminal, and a method for displaying a menu based on the use record in the mobile terminal are described hereinafter.

FIG. 6 is a block diagram illustrating a configuration of a mobile terminal for performing a method of displaying a menu according to another exemplary embodiment of the present invention.

Referring to FIG. 6, a mobile terminal 60 includes a key input unit 61, display unit 62, controller 63, and storage unit 64.

The mobile terminal 60 may be a personal information terminal such as various types of mobile phones, a smart phone, Personal Digital Assistant (PDA), mobile broadcasting receiver such as a Digital Multimedia Broadcasting (DMB) receiver, multimedia player such as an MP3 player and Portable Multimedia Player (PMP), and other mobile electronic appliances having a key input unit and a display unit.

The key input unit 61 detects a user's manipulation operation and generates an input signal according to the manipulation operation. The key input unit 61 includes a hotkey for entering a menu screen and a 4-way navigation key for moving a focus to items. The hotkey may be a separate key, or an existing key to which a menu entry function is mapped. The key input unit 61 can use an input device such as a keypad, touch pad, and jog.

The display unit 62 displays various information related to a state and operation of the mobile terminal 60. Particularly, the display unit 62 displays menu items based on a use record. The display unit 62 generally uses a Liquid Crystal Display (LCD), however may use other display devices.

The controller 63 is a microprocessor for controlling general operations of the mobile terminal 60. Particularly, the controller 63 includes a menu display control module 65 and a using record control module 66. The menu display control module 65 receives key input related to menu display from the key input unit 61 to control the using record control module 66, and controls the display unit 62 to display menu items based on the use record. The using record control module 66 extracts or updates use records stored in the storage unit 64.

The storage unit 64 stores various programs and data executed and processed in the mobile terminal 60, and includes at least one volatile memory element and at least one non-volatile memory element. Particularly, the storage unit 64 includes a using record database (DB) 67 and stores a use record in the using record DB 67. The use record is shown in FIG. 3.

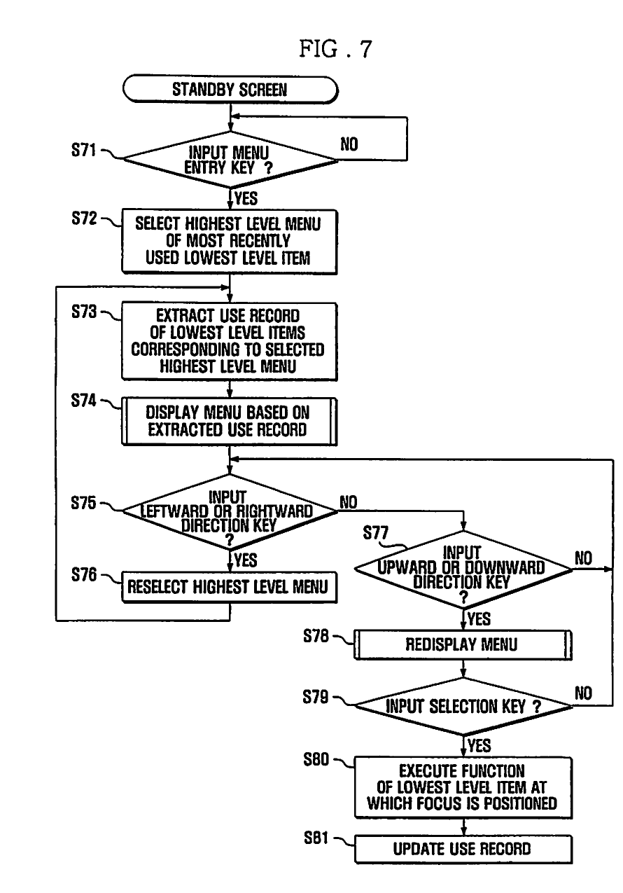

FIG. 7 is a flowchart illustrating a method of displaying a menu according to another exemplary embodiment of the present invention.

Referring to FIGS. 6 and 7, in a standby state, the menu display control module 65 determines whether a menu entry key is input from the key input unit 61 (step S71). The input of the menu entry key may be input of a hotkey or of a communication key.

If a menu entry key is input from the key input unit 61, the menu display control module 65 determines the most recently used lowest level item and determines a highest level menu of the item from the using record DB 67, and selects the highest level menu of the most recently used lowest level item (step S72). For example, if the most recently used lowest level item is the item ‘A12’ of FIG. 1, a highest level menu ‘A’ of the item ‘A12’ is selected. This step may be performed through the using record control module 66. Instead of such a selection method, a method of always selecting a specific menu may be used. For example, when entering a main menu by pressing a communication key, a sending communication list may always be selected.

The menu display control module 65 extracts a use record of lowest level items corresponding to the selected highest level menu from the using record DB 67 by controlling the using record control module 66 (step S73). For example, if the selected highest level menu is ‘A’, a use record of the lowest level items ‘A11’ to ‘A22’ corresponding to the menu ‘A’ is extracted. The use record includes a use ranking and a use history, as shown in FIG. 3.

The menu display control module 65 displays a menu based on the extracted use record (step S74).

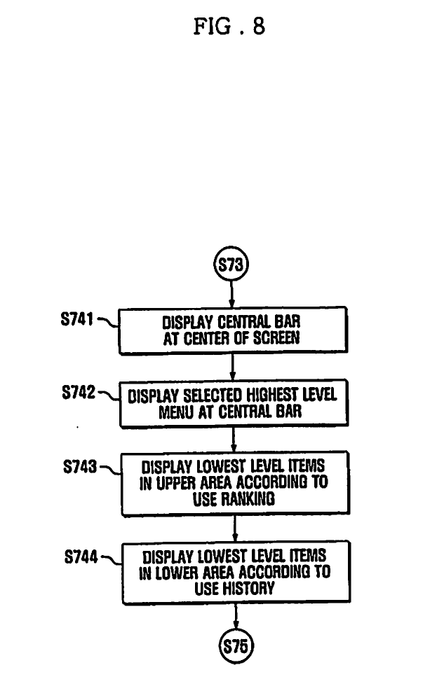

FIG. 8 is a flowchart illustrating step S74 of displaying a menu in more detail.

Referring to FIGS. 4A, 6, and 8, the menu display control module 65 displays the central bar 41 at the center of a screen of the display unit 62 (step S741), and the selected highest level menu ‘A’ is displayed at the central bar 41 (step S742). As shown in FIG. 4A, the highest level menus are displayed in the form of the icons 42 at the central bar 41, and the selected highest level menu ‘A’ uses a large icon 42 and displays the item name 44 for identification to distinguish it from other menus.

The menu display control module 65 displays the lowest level items based on the use record extracted by the using record control module 66. That is, the lowest level items are displayed in the upper area 45 according to their use ranking (step S743), and the lowest level items are displayed in the lower area 46 according to their use history (step S744). An item having a highest use ranking and an item having a most recent use history are disposed at a position adjacent to the central bar 41.

Returning to FIGS. 6 and 7, after the menu is displayed based on the use record, the menu display control module 65 determines whether a leftward or rightward direction key is input (step S75). If a leftward or rightward direction key is input, the menu display control module 65 reselects a highest level menu displayed at the central bar 41 according to the key input (step S76). For example, when the currently selected highest level menu is ‘A’, if the rightward direction key is input, a highest level menu ‘B’ positioned at the right side of the highest level menu ‘A’ is selected. The process returns to step S73 and a process of extracting the use record of the lowest level items corresponding to the selected highest level menu is again performed. That is, a use record of the lowest level items ‘B11 to B32’ corresponding to the reselected highest level menu B is extracted. Thereafter, a menu is displayed again based on the extracted use record at step S74.

FIG. 4D is an example of a screen illustrating a process of reselecting a highest level menu and displaying the corresponding lowest level items in the method of displaying a menu.

If a leftward or rightward direction key is not input at step S75, the menu display control module 65 determines whether an upward or downward direction key is input (step S77).

If an upward or downward direction key is not input, the process returns to step S75. If an upward or downward direction key is input, the menu display control module 65 redisplays a menu (step S78).

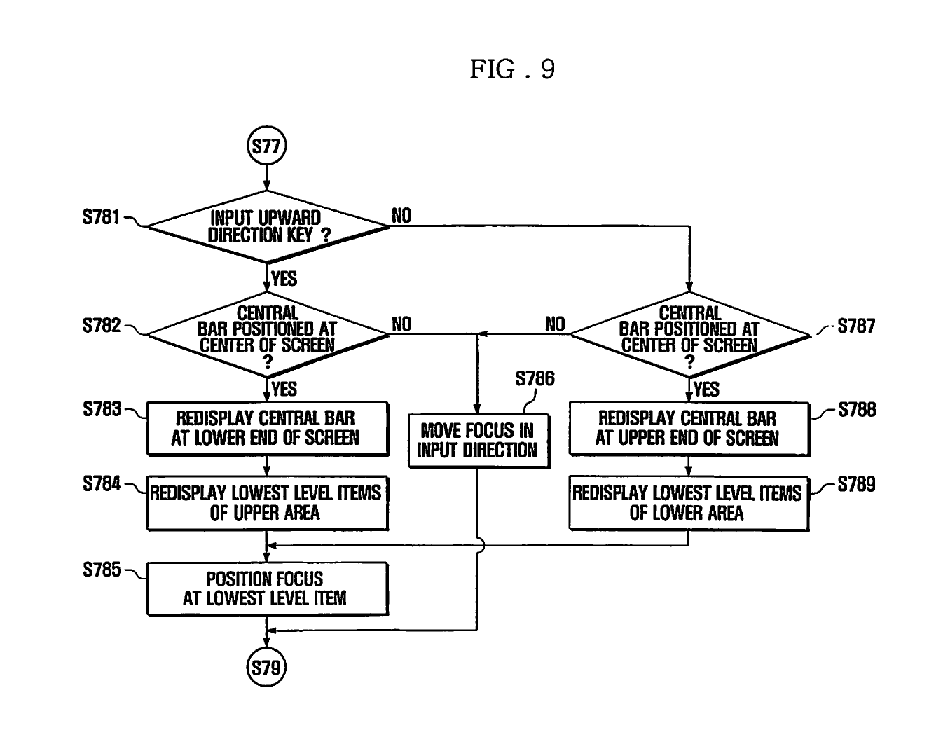

FIG. 9 is a flowchart illustrating step S78 of redisplaying a menu in more detail.

Referring to FIGS. 4B, 4C, 6, and 9, the menu display control module 65 determines whether the upward direction key is input (step S781). If the upward direction key is input, the menu display control module 65 determines whether the central bar 41 is positioned at the center of the screen of the display unit 62 (step S782). If the central bar 41 is positioned at the center of the screen of the display unit 62, the central bar 41 is redisplayed at the lower end of the screen (step S783), as shown in FIG. 4B.

As the central bar 41 is redisplayed, the lowest level items of the upper area 45 are also redisplayed (step S784), and the second focus 47 is positioned at the lowest level item immediately adjacent to the central bar 41 (step S785).

If the upward direction key is not input at step S781, (that is, if the downward direction key is input), the menu display control module 65 determines whether the central bar 41 is positioned at the center of the screen of the display unit 62 (step S787). If the central bar 41 is positioned at the center of the screen of the display unit 62, the central bar 41 is redisplayed at the upper end of the screen (step S788), as shown in FIG. 4C. As the central bar 41 is redisplayed, the lowest level items of the lower area 46 are also redisplayed (step S789), and the second focus 47 is positioned at the lowest level item immediately adjacent to the central bar 41 at step S785.

If the central bar 41 is not positioned at the center of the screen at either of step S782 or step S787, this mean that the central bar 41 is positioned at the lower end or the upper end of the screen, and the second focus 47 is positioned at one of the displayed lowest level items. In this case, because the upward direction key or the downward direction key is input to move the second focus 47, the menu display control module 65 moves the second focus 47 in a direction corresponding to the input upward pr downward direction key (step S786).

Returning to FIGS. 6 and 7, after the menu is redisplayed by input of the upward direction key or the downward direction key at step S78, the menu display control module 65 determines whether the selection key is input (step S79). If the selection key is not input, the process returns to step S75. If the selection key is input, the controller 63 executes a function of the lowest level item at which the second focus 47 is positioned (step S80).

The using record control module 66 updates a use record stored in the using record DB 67 (step S81). The updated use record is used as a base of menu display at the following time of entering a menu.

As described above, according to the present invention, items such as a function and a content to be used by the user are selectively displayed based on a use record such as a use ranking and use history. That is, by selectively displaying items having a higher use ranking or items having a more recent use history, a user can more easily and rapidly access a desired item. Particularly, by using both a use ranking and use history in menu display, a user request can be smoothly performed.

Further, in a method of displaying a menu, because it is unnecessary to pass through higher level items in order to access a lowest level item, user manipulation is simplified. Further, a conventional manipulation process of registration and deletion of a shortcut is not required.

Further, whenever the user uses a lowest level item, a use record is updated, and the menu is thus redisplayed, whereby a user's individual use characteristics can be reflected.

Further, because a method of displaying a menu according to the present invention is not influenced by increase of a function or content, the method can be conveniently used.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A method of displaying a menu based on a use record in a mobile terminal, comprising:
selecting one of at least two highest level menus;
extracting a use record of lowest level items corresponding to the selected highest level menu; and
displaying the selected highest level menu and the lowest level items based on the use record.

2. A method of displaying a menu based on a use record in a mobile terminal, comprising:
selecting a highest level menu among at least two highest level menus;
extracting a use record, the use record comprising a use ranking and a use history of lowest level items corresponding to the selected highest level menu;
displaying the selected highest level menu on a screen; and
displaying the lowest level items on the screen based on the use record.

3. The method of claim 2, further comprising:
selecting, by input of one of a leftward direction key and a rightward direction key after the lowest level items are displayed, an other highest level menu among the at least two highest level menus;
extracting a use record of lowest level items corresponding to the selected other highest level menu;
displaying the selected other highest level menu on the screen; and
displaying the lowest level items corresponding to the selected other highest level menu on the screen based on the use record.

4. The method of claim 2, wherein displaying the selected highest level menu on a screen comprises displaying the selected highest level menu at the center of the screen, and wherein displaying the lowest level items on the screen comprises displaying the lowest level items in each of an upper area and a lower area of the screen based on the use ranking and use history, respectively.

5. The method of claim 4, wherein displaying the lowest level items on the screen comprises disposing lowest level items having one of a highest use ranking and a most recently used history at positions adjacent to the selected highest level menu.

6. The method of claim 4, wherein displaying the selected highest level menu on the screen comprises displaying the selected highest level menu and remaining highest level menus of the at least two highest level menus, wherein the selected highest level menu is displayed to be identified as the selected highest level menu among the at least two highest level menus.

7. The method of claim 4, further comprising:
displaying, when an upward direction key is input after displaying the lowest level items, the selected highest level menu at the lower end of the screen; and
displaying the lowest level items in the upper area of the screen based on the use ranking.

8. The method of claim 7, further comprising displaying a focus at a lowest level item adjacent to the selected highest level menu.

9. The method of claim 8, further comprising:
executing, when a selection key is input, a function of the lowest level item at which the focus is displayed; and
updating the use record.

10. The method of claim 4, further comprising:
displaying, when a downward direction key is input after displaying the lowest level items, the selected highest level menu at the upper end of the screen; and
displaying the lowest level items in the lower area of the screen based on the use history.

11. The method of claim 10, further comprising displaying a focus at a lowest level item adjacent to the selected highest level menu.

12. The method of claim 11, further comprising executing, if a selection key is input, a function of the lowest level item at which the focus is displayed, and updating the use record.

13. The method of claim 2, wherein selecting a highest level menu among the at least two highest level menus comprises selecting a highest level menu of a most recently used lowest level item.
